(19) United States
(12) Patent Application Publication
(10) Pub. No.: US 2019/0024616 A1
(43) Pub. Date: Jan. 24, 2019

(54) ALTERNATIVE FUEL RETROFIT KIT FOR A COMBUSTION ENGINE

(71) Applicant: SVMTech, LLC, Costa Mesa, CA (US)

(72) Inventor: Serge V. Monros, Costa Mesa, CA (US)

(73) Assignee: SVMTech, LLC, Tokyo (JP)

(21) Appl. No.: 16/038,918

(22) Filed: Jul. 18, 2018

Related U.S. Application Data
(60) Provisional application No. 62/533,808, filed on Jul. 18, 2017.

(51) Int. Cl. F02M 37/00; F02D 19/06; F02D 41/00; F02M 43/04

(52) U.S. Cl. CPC F02M 37/0064; F02D 19/066; F02D 41/0025; F02M 2200/95; F02M 37/0076; F02M 43/04; F02M 2200/248; F02M 37/0023

(57) ABSTRACT

A retrofit-kit converts an existing internal combustion engine running on gasoline or diesel to run on either the old fuel or an alternative fuel such as compressed natural gas, liquid petroleum, hydrogen, propane, etc. The kit provides a new fuel tank for the alternative fuel, fuel injectors specifically calibrated for the type of alternative fuel used in the kit, as well as gasoline or diesel, and a micro-controller which reads existing engine sensors to allow for fine-tuned injection of the alternative fuel, along with regulation of blow-by gas recycling.

### FIELD OF THE INVENTION

The present invention generally relates to automotive engine technology. More specifically, the present invention is directed to a retro-fit kit for converting a standard combustion engine to a fine-tuned, electronically controlled, alternative fuel burning engine.

### BACKGROUND OF THE INVENTION

Currently, the most accepted method of metering fuel to internal combustion engines is through the use of pulse-width-modulated solenoid valves commonly referred to as fuel injectors. There are two types of fuel injection systems that are commonly used in combustion powered automobile engines, direct injection and port injection. For a direct fuel injection system, the fuel injectors are oriented with one end of the fuel injector mounted in the cylinder head to allow the fuel injector to spray fuel directly into the engine cylinder. The other end of the fuel injector is in position to receive fuel from a manifold device. For a port injection system, the fuel injectors are oriented with one end of the fuel injector in the intake manifold runners and the fuel sits in the runners until the intake valve opens and the mixture is pulled into the cylinders while the other end of the fuel injector is in position to receive fuel from a manifold device. The fuel injectors used in fuel injection systems are calibrated for the specific type of fuel the automobile runs on.

The central component, or brain, of these fuel injection systems is the engine control module (ECM). The ECM typically contains a micro-controller that receives information from various sensors located throughout the engine. These sensors generally include: the engine coolant temperature sensor, the manifold absolute pressure sensor, the knock sensor, the throttle position sensor, the mass air flow sensor, the exhaust gas oxygen sensor, the oil pressure sensor, the vehicle speed sensor, and the exhaust gas recirculation valve position sensor. The ECM controls the operation of the engine by receiving signals from these various sensors and then by adjusting the functioning of the engine accordingly. For example, the ECM controls the operation of the engine by metering the consumption of fuel via the fuel injectors, and by controlling the timing of the firing of the spark plugs.

While the standard fuel for automobiles in the United States is gasoline, there are many advantages of converting internal combustion engines to run on alternative fuels. First, use of alternative fuels can help consumers address concerns about fuel costs. With gasoline prices rising, some alternative fuels such as natural gas, may provide a better option for the average American consumer. Second, alternative fuels provide energy security. Alternative fuels can be made here at home in the United States from a variety of agricultural feedstock thereby reducing our consumption and dependency on foreign oil. Third, many alternative fuels burn cleaner than gasoline. Atmospheric pollution generated by exhaust emissions from conventional gasoline powered internal combustion engines is a well-documented problem. Since alternative fuels generally burn cleaner, conversion to alternative fuels would greatly help with the pollution problems many cities and urban areas are facing. Fourth, alternative fuels may prove better for an engine than gasoline. For example, use of alternative fuels may prevent frequent knocking and eliminate phenomena such as vapor-lock.

To date, most commercially viable technologies used for converting gasoline powered engines to an alternative fuel are mechanically controlled systems. These mechanically controlled systems are incapable of meeting modern vehicle engine requirements. In particular, they fail to provide the responsiveness, power, or fuel efficiency expected by drivers or the exhaust emission levels now legislated by many regulatory authorities.

Because of the problems associated with mechanical systems for alternative fuel injection, modern and sophisticated electronically controlled systems have been invented for converting gasoline engines to engines that run completely on an alternative fuel, or to engines that run on a mixture of fuels. The most notable of these inventions are briefly discussed below.

U.S. Pat. No. 5,092,305 to King describes an alternative fuel system that operates in conjunction with the primary fuel system to utilize the output from the existing original equipment manufacturer's control module in the primary system. It modifies the original equipment manufacturer's control signals to operate a fuel supply valve for the alternative fuel so that the proper quantity of alternative fuel is supplied to the engine. The primary fuel is not mixed with the alternative fuel. A selector is provided for determining which of the fuels is supplied to the engine. Spark control is supplied by the original equipment control module. There are several disadvantages to this type of system. One of the principle disadvantages is that a gaseous fuel such as natural gas performs differently than liquid fuels such as gasoline. Because of this, different fueling is required during various engine operating modes such as cold start, warm-up, power enrichment and transient periods during which different torque requirements may be necessary. In addition, gaseous fuels require different ignition timing control than liquid fuels. Since this system relies on the original equipment manufacturer's timing signals for ignition control, optimal performance and minimal emissions cannot be realized. Engine spark timing must be advanced significantly when running on natural gas to compensate for the fact that natural gas burns more slowly than gasoline and therefore needs to be ignited earlier in order to exert maximum mean pressure downward on the piston.

U.S. Pat. No. 5,379,740 to Moore et al. describes a dual fuel injection arrangement for an internal combustion engine similar to that in the U.S. Pat. No. 5,379,740 to King. However, the arrangement uses only one set of fuel injectors to deliver either a first or a second fuel to the engine cylinders without mixing the fuels. The primary electronic control unit determines injection timing for the first fuel based on a number of engine parameters. A second electronic control unit takes into account characteristics of the second fuel and adjusts signals from the first electronic control unit to produce proper injection timing for the second fuel. This system presents the same disadvantages as the King system.

U.S. Pat. No. 5,735,253 to Perotto et al. describes another duel fuel injection arrangement for an internal combustion engine. This system provides two sources of fuel as well as two sets of fuel injectors, the first set for the first fuel and the second set for the second fuel. A primary electronic control unit controls the injection timing for the first fuel. A secondary electronic control controls the injection timing for the second fuel and also controls a switch system whereby the engine can switch between three different modes of operation: operation on the first fuel, operation on the second fuel, or operation on a mixture of the first and second fuels. Furthermore, while the primary electronic control unit is still in control of the ignition system, the secondary electronic control unit receives signals with respect to the ignition system modifies these for the various operation modes and conveys these modified signals back to the primary electronic control unit so that ignition control is calibrated for the specific mode of operation.

U.S. Pat. No. 6,289,881 B1 to Klopp describes another method of converting a gasoline engine to operate on an alternative fuel. A gaseous fuel tank is installed along with the gasoline fuel tank. An electronic controller is provided that receives signals from the various engine parameters and controls the ignition and fuel injectors for optimal performance. The engine runs completely on gaseous fuel alone at all times until maximum engine torque is demanded. When maximum engine torque is demanded, the engine switches to run solely on a liquid fuel. The fuels are not mixed. The major drawback of this system is that the two fuel tanks must fit in the car as well as injectors for the alternative fuel and injectors for gasoline. For a car with limited space it may be difficult to retrofit all of the additional equipment.

U.S. Pat. No. 7,607,422 to Carlson et al. describes yet another method of converting a standard gasoline engine to be fuel flexible. A mixed fuel is used as provided in a single fuel tank. A flexible fuel electronic control unit is added to the engine to receive signals from the various engine parameters and to modify signals from the original engine control module. The flexible fuel electronic control unit controls ignition timing and the air to fuel ratio of the engine based upon the composition of the fuel mixture in the fuel tank. This is advantageous in that the ignition timing matches the composition of the fuel mixture for optimal engine performance, but also has the drawbacks of (1) having to find a place for an extra computer unit, and (2) the inconvenience of having to find sources for two different fuels and then mixing them in the proper ratio for optimal engine performance.

U.S. Patent Application Publication No. 2011/0288745 to Warner et al. describes a multi-mode engine system allowing the engine to run on a first fuel, a second fuel, or mixture of the two fuels. The engine includes a first electronic control unit which receives input signals from a plurality of sensors and sends output signals to a plurality of first fuel injectors or to a second electronic control unit. The second electronic control unit receives the output signals from the first electronic control unit as input and uses these signals to create a first modified signal monitoring and metering the amount of a first fuel injected and a second calculated signal monitoring and metering the amount of a second fuel injected.

Accordingly, there is a need for a retro-fit kit that allows for the conversion of an engine that runs on gasoline to an engine that runs on an alternative fuel that includes a micro-controller that automatically controls the flow of fuel through computer logic based on sensed engine conditions and also controls ignition timing and is also compact in size to allow for simple replacement, even in compact cars. The present invention fulfills those needs and provides other related advantages.

### SUMMARY OF THE INVENTION

The present invention is directed to an alternative fuel retrofit kit for an internal combustion engine. The kit includes a retrofit fuel tank, a conjunction box fluidly connected to the retrofit fuel tank, a plurality of fuel injectors fluidly connected to the conjunction box, fuel valve in the conjunction box fluidly in-line between the retrofit fuel tank and the plurality of fuel injectors, and a microcontroller operatively connected to the fuel valve.

The kit may further include a blow-by gas recirculating system. The blow-by gas recirculating system includes a PCV valve, a vent line fluidly connecting a crankcase of an engine to the PCV valve, and a recirculating line fluidly connecting the PCV valve to the conjunction box. The microcontroller may also be operatively connected to the PCV valve to regulate an open/close state of the PCV valve in response to engine sensor signals.

The kit may further include retrofit fuel injection rails and retrofit fuel injectors, wherein the retrofit fuel injection rails and retrofit fuel injectors are configured to deliver multiple types of fuel to the engine, depending upon the fuel tanks and the microcontroller.

The present invention is also directed to a process for installing a fuel retrofit kit on an internal combustion engine. The process includes the step of installing a retrofit fuel tank in a vehicle containing an engine. The retrofit fuel tank may be installed in parallel with an old fuel tank or as a replacement for an old fuel tank. When installed in parallel, the old fuel tank is fluidly connected to an old fuel inlet on the conjunction box. When installed as a replacement, the old fuel tank is removed from the vehicle.

The process also includes installing a conjunction box in a compartment proximate to the engine, and installing retrofit fuel rails on the engine. The retrofit fuel rails have a plurality of retrofit fuel injectors, with each retrofit fuel injector corresponding to one of a plurality of piston cylinders in the engine. The old fuel rails and old fuel injectors may be removed from the engine. The retrofit fuel tank is then fluidly connecting to a retrofit inlet on the conjunction box, and an outlet on the conjunction box is fluidly connecting to the retrofit fuel rails.

A microcontroller is operatively connected to the conjunction box, such that the microcontroller regulates a type and amount of fuel passing through the conjunction box. A PCV valve may be installed proximate to the engine, with an inlet on the PCV valve being fluidly connected to a crankcase on the engine and an outlet on the PCV valve fluidly connected to a blow-by inlet on the conjunction box. The microcontroller is programmed to blend the blow-by inlet with the fuel inlet.

The step of fluidly connecting the retrofit fuel tank to a retrofit inlet on the conjunction box further includes running high pressure tubing and fittings between the fuel tank and the retrofit inlet such high pressure tubing and fittings are preferably clamped to a chassis of the vehicle.

A plurality of sensor leads from an engine temperature sensor, a PCV valve sensor, a fuel tank sensor, or an exhaust sensor are preferably connected to the microcontroller. The microcontroller is to be programmed with standard values for the engine temperature sensor, the PCV valve sensor, the fuel tank sensor, or the exhaust sensor corresponding to an alternative fuel in the retrofit fuel tank.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a top perspective view of a retro-fit fuel injector kit for an internal combustion engine embodying the present invention as seen in place through the outline of an automobile;

FIG. 2 is a top perspective view of the retro-fit fuel injector kit of FIG. 1, illustrating the various components thereof;

FIG. 3 is a flow chart of a process of installing the retro-fit fuel injector kit of FIGS. 1 and 2;

FIG. 4 is a top perspective view of a retro-fit fuel injector kit for an internal combustion engine installed in parallel with the old fuel equipment as seen in place through the outline of an automobile;

FIG. 5 is a schematic view of a retro-fit fuel injector kit for an internal combustion engine installed with a blow-by gas PCV valve recirculating system; and

FIG. 6 is a top perspective view of a retro-fit fuel injector kit with a blow-by gas PCV valve recirculating system for an internal combustion engine embodying the present invention as seen in place through the outline of an automobile.

### DETAILED DESCRIPTION OF THE PREFERRED EMBODIMENTS

As shown in the drawings, the present invention is directed to a retro-fit fuel injector kit and a process for converting a standard internal combustion engine—running on gasoline or diesel fuel—to an alternative fuel burning engine for which the alternative fuel may be natural gas, propane, liquid hydrogen, LPG, LNG, CNG, etc. The retro-fit kit may completely replace the old fuel equipment, providing a new fuel tank, high pressure tubing, fittings, electronic control unit, and new fuel injectors. In fact, the new fuel injectors preferably replace the original fuel injectors with systems that are compatible with either the original fuel or the alternative fuel. Furthermore, the retro-fit kit includes a micro-controller to detect engine conditions based on various existing engine sensors in order to control and adjust the injection of the alternative fuel and the ignition timing so as to keep the sensor signals close to set engine parameter values for the specific alternative fuel used. The retrofit kit may also be installed in parallel with the old fuel equipment.

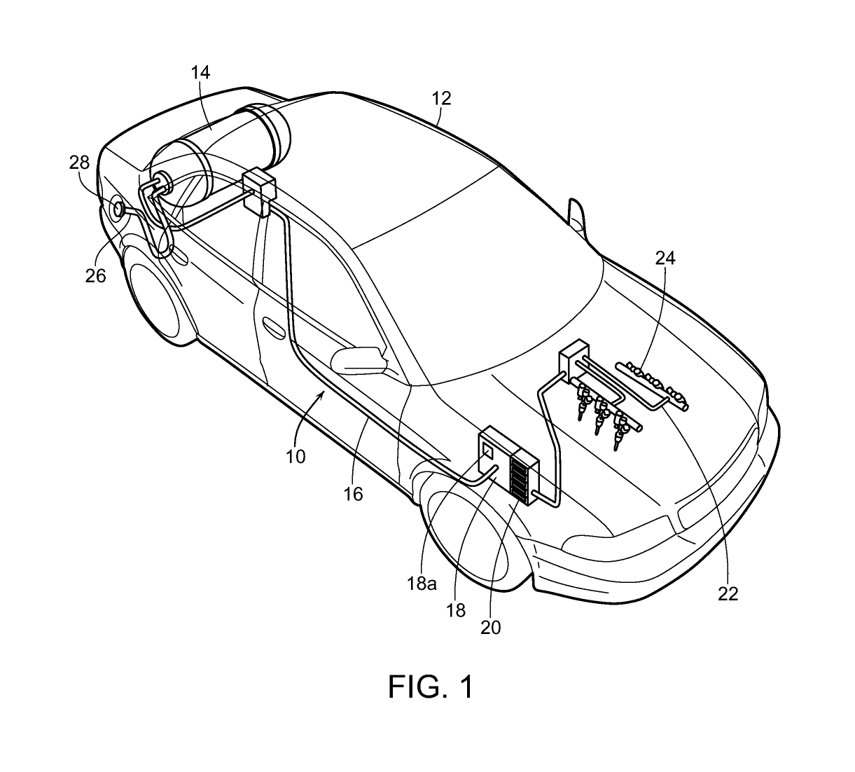

FIG. 1 shows a top perspective view of the retro-fit kit 10 embodying the present invention as it is installed in an automobile 12 in replacement of the old fuel system. The retro-fit kit 10 is comprised of a new fuel tank 14 for the alternative fuel, high pressure tubing and fittings 16, a conjunction box 18, a micro-controller 20, fuel injection rails 22, and fuel injectors 24. As mentioned above, the new fuel injector rails 22 and new fuel injectors 24 are preferably installed in place of the original fuel injectors (not shown) from the original fuel system. The new injector rails 22 and new fuel injectors 24 are dual purpose, configured to deliver either the original fuel or the alternate fuel to the combustion chamber.

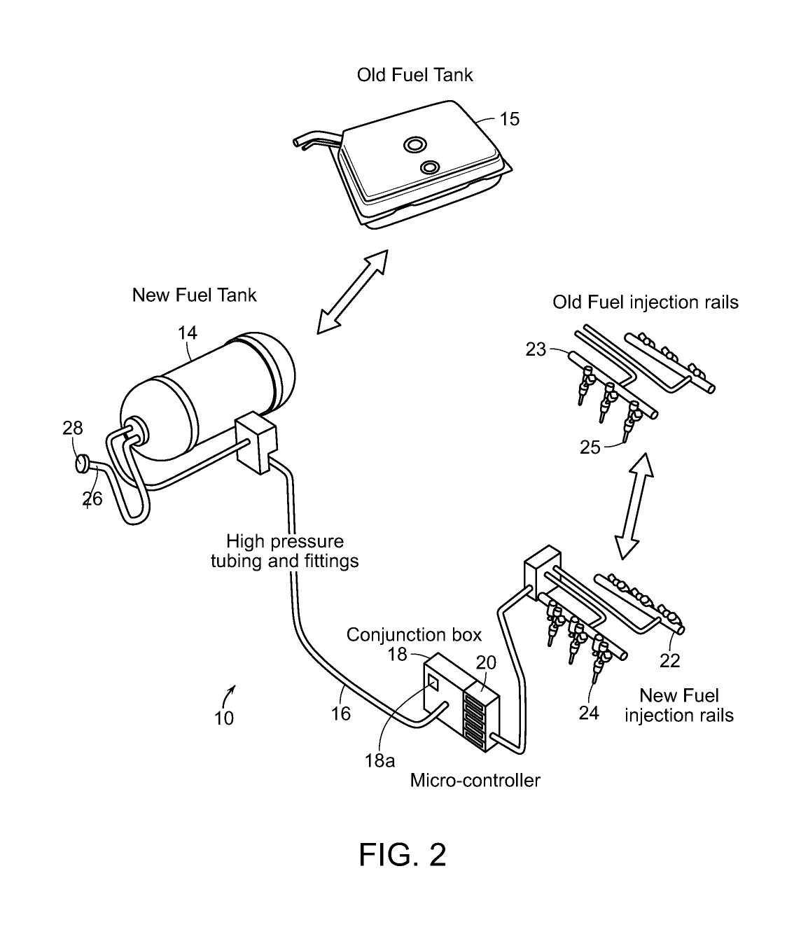

FIG. 2 is a top perspective view of the assembled retro-fit kit 10 illustrating all of the various components. The new fuel tank 14 for the alternative fuel may either replace or be installed in parallel with the old fuel tank 15 which contained gasoline, diesel, or any other type of fuel which the operator wants to stop using. The new fuel tank 15 is designed to house the specific alternative fuel associated with the retro-fit kit 10—natural gas, propane, liquid hydrogen, LPG, LNG, CNG, etc.

The composition of the new fuel tank 15 may be made of material well known in the art for storing the specific type of alternative fuel used. For example, for the retro-fit kit 10 meant for conversion to compressed natural gas as the alternative fuel, the new fuel tank 15 will be composed of either heavy steel, steel liner with fiberglass or carbon fiber hoop wrapped around the sides of the cylinder, aluminum liner with carbon fiber wrapping the entire cylinder, or polyethylene liner with carbon fiber wrapping the entire cylinder, as these materials are commonly used in the art for storing compressed natural gas.

The high pressure tubing and fittings 16 provide a pathway from the fuel tank 14 to the fuel injectors 24 where the fuel is released into the cylinders for combustion. The tubing and fittings 16 are made up of a fuel filler neck 26, which goes from the new fuel tank 14 to an orifice (not shown) that is sealed with a cap 28 which may be removed to fill the tank with the alternative fuel in a manner well known in the art. Another tube is connected to a fuel pump (not shown) and extends to the conjunction box 18 and then from the conjunction box 18 to the fuel rails 22 where the alternative fuel may be provided to the fuel injectors 24.

The conjunction box 18 has two main functions. The first is to control the flow of fuel. As previously discussed, the high pressure tubing 16 extends to the conjunction box 18 and then from the conjunction box 18 to the fuel rails 22. The conjunction box 18 contains a valve for controlling the flow of fuel from either the original tank or the new retrofit tank 14. This function of the conjunction box 18 is controlled by the micro-controller 20 in response to signals received from the various engine sensors. The second function of the conjunction box 18 is to receive signals from the various engine sensors. To accomplish this task, the conjunction box 18 contains servos to which the various engine sensors may be connected. These sensors generally include: the engine coolant temperature sensor 64, the manifold absolute pressure sensor, the knock sensor, the throttle position sensor, the mass air flow sensor, the exhaust gas oxygen sensor 70, the oil pressure sensor, the vehicle speed sensor, and the exhaust gas recirculation valve position sensor 68.

The micro-controller 20 is contained within the conjunction box 18. The micro-controller 20 controls the functioning of the engine by reading signals received by the conjunction box 18 and then by providing negative feedback signals to control the various engine parameters. The conjunction box 18 contains the standard values of such engine parameters for the specific type of alternative fuel to be used with the retro-fit kit 10. For example, the value of the air/fuel ratio needed to reach a stoichiometric mixture for the specific alternative fuel is used in order to allow enough air in the cylinder to combust the maximum amount of fuel. The micro-controller 20 compares these standard values to the signals received and then sends feedback signals to keep the signals from the various engine parameters close to these standard values.

For example, it is advantageous to keep the air/fuel ratio at its stoichiometric mixture during light load conditions. The signals from the exhaust gas oxygen sensor will inform the micro-controller 20 how close the engine is to its stoichiometric air/fuel ratio under light load conditions. The micro-controller 20 can then send feedback signals to increase or decrease the amount of fuel injected by the fuel injectors 24 to bring the reading from the oxygen sensor closer to that which results from the standard stoichiometric air/fuel ratio for the specific type of alternative fuel used.

The new fuel injection rails 22 and fuel injectors 24 replace the old fuel rails 23 and the old fuel injectors 25. The new fuel rails 22 are connected to the high pressure tubing 16 allowing them to receive fuel and disseminate the fuel to the fuel injectors 22. The fuel injectors 22 are calibrated for the specific type of alternative fuel to be used with the retro-fit kit 10. At least one fuel injector 22 is provided in the retro-fit kit 10, but typically one fuel injector 22 is provided for each cylinder of the engine: two, four, six, eight, etc. the fuel injectors 22 may be connected for direct injection or port injection depending on the set up of the engine to be converted to run on an alternative fuel.

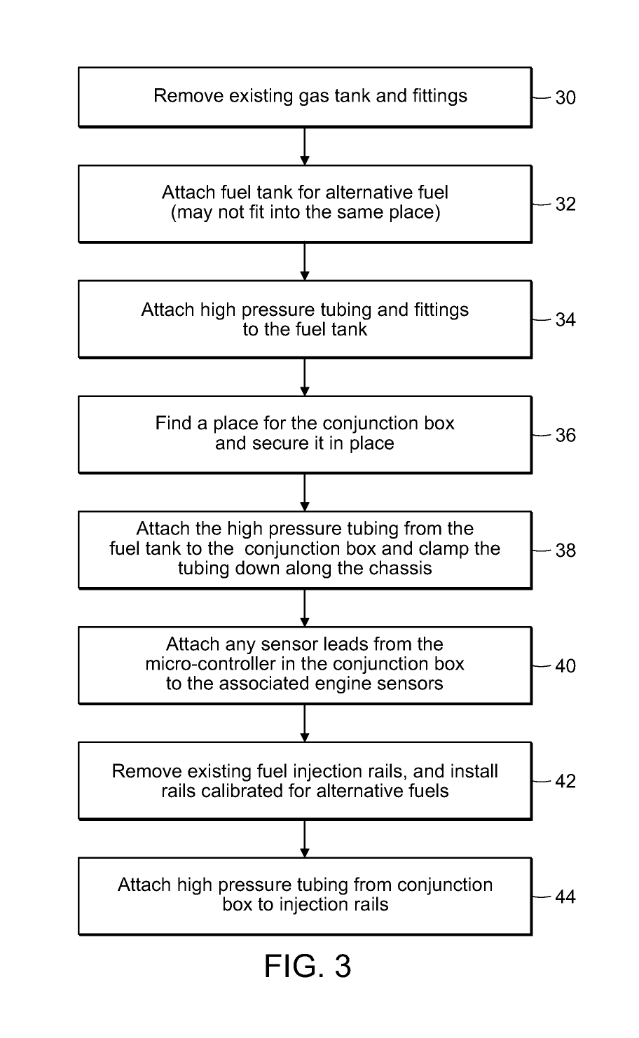

FIG. 3 shows a flow-chart of how the retro-fit kit 10 is installed into an automobile. The first step 30 is to remove the existing gas tank 15, the old gas tubing, and the old fittings. The second step 32 is to attach the new fuel tank 14 for the alternative fuel. Depending on the type of alternative fuel used in the retro-fit kit 10 and on the size of the new fuel tank 14, the new fuel tank 14 may not fit in the same place as the old fuel tank 15. The third step 34 is to attach the high pressure tubing and fittings 16 to the new fuel tank 14. The fourth step 36 is to find a place for the conjunction box 14 and to secure it. The conjunction box 14 should preferably be placed somewhere under the hood of the car and close to the engine so as to allow easy connection to the various engine sensors. The fifth step 38 is to attach the high pressure tubing 16 from the new fuel tank 14 to the conjunction box and to clamp the tubing 16 down along the chassis of the vehicle 12. The sixth step 40 is to attach any sensor leads from the micro-controller 20 in the conjunction box 18 to the associated engine sensors. The seventh step 42 is to remove the existing fuel injection rails 23 and fuel injectors 25, and to install the new fuel rails 22 and the new fuel injectors 24 which are calibrated for the specific alternative fuel used in the retro-fit kit 10. The eighth and final step 44 is to attach the high pressure tubing 16 from the conjunction box 18 to the new fuel injection rails 22.

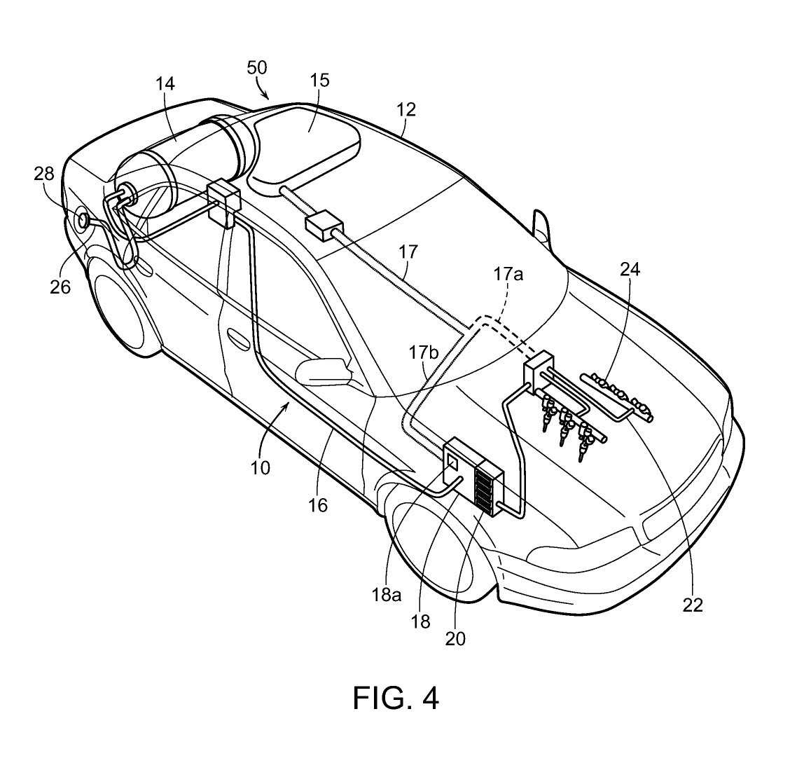

FIG. 4 shows a top perspective view of the retro-fit kit 10 embodying the present invention as it is installed in an automobile 12 in parallel with an old fuel system 50. The old fuel system 50 consists of an old fuel tank 15 with an old fuel line 17. Prior to installation of the retro-fit kit 10, the old fuel line 17a was connected to old fuel injector rails 23, which are removed as part of the installation of the retro-fit kit 10. The retro-fit kit 10 is as described above. In this parallel installation, the old fuel line 17 is connected by a new line 17b to the conjunction box 18 as is the high pressure tubing 16. In this way, the micro-controller 20 can control the flow of both the old fuel tank 15 and the retro-fit fuel tank 14. The old fuel injection rails 23 and old fuel injectors 25 are replaced with the retro-fit fuel injection rails 22 and retro-fit fuel injectors 24 that are compatible with either the old fuel or the new alternative fuel.

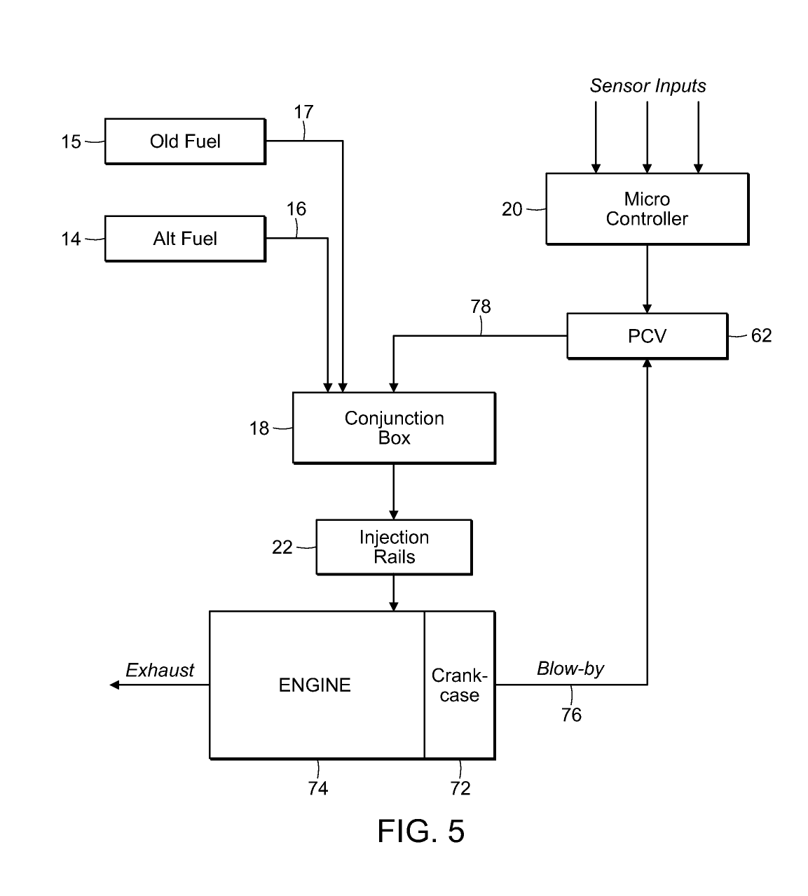

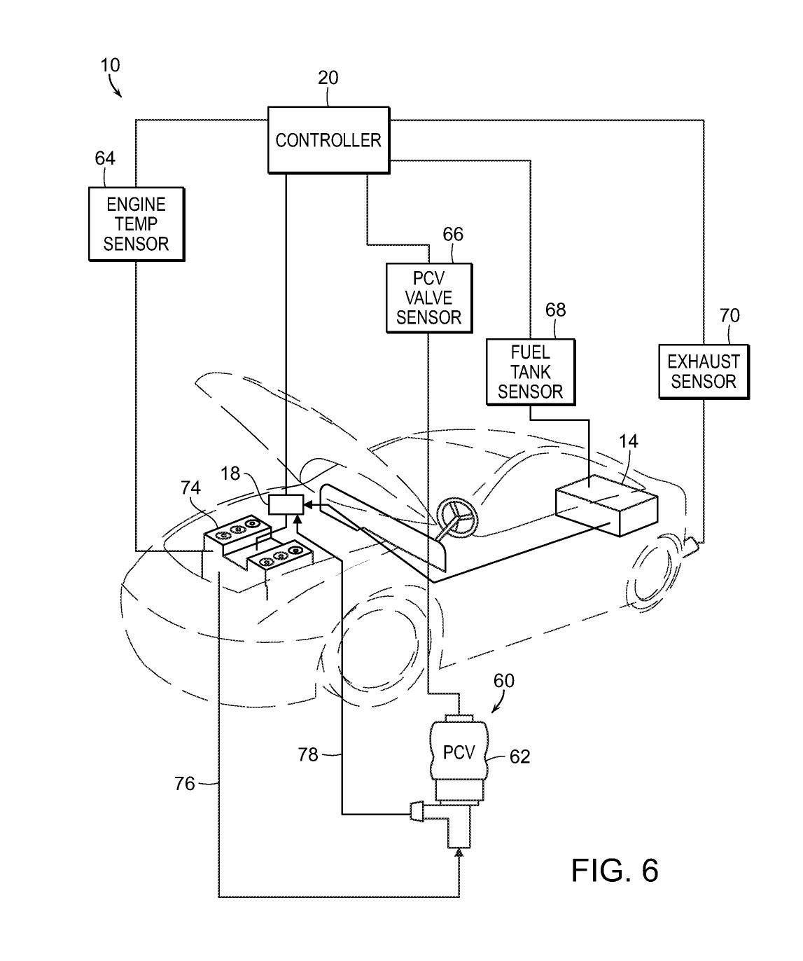

The system 10 may also be combined with a blow-by gas recycling system 60. With reference to FIGS. 5 and 6, in a particularly preferred embodiment a PCV valve 62, which is controlled by the microcontroller 20, regulates the flow of blow-by gasses drawn from the engine crankcase 72 and supplied to the engine 74 for burning. The microcontroller 20 regulates the flow rate of blow-by gases by regulating the engine vacuum in a combustion engine through digital control of a PCV valve 62. The microcontroller 20 receives real-time input from sensors that might include an engine temperature sensor 64, a PCV valve sensor 66, a fuel tank sensor 68, and an exhaust sensor 70. Data obtained from the sensors 64-70 by the microcontroller 20 is used to regulate the open/close state of the PCV valve 62.

FIG. 5 is a schematic illustration of the PCV valve 62 within the pollution control system 60. As shown, the PCV valve 62 is disposed between a crankcase 72 of the engine 74 and the conjunction box 18. In operation, PCV valve 62 receives the blow-by gases from the crankcase 74 through a vent or recycle line 76. The conjunction box 18 receives either the old fuel or the alternative fuel and is mixed with the blow-by gas stream from return line 78 the PCV valve 62. Alternatively, the blow-by from the PCV valve 62 may be introduced into an intake manifold (not shown) or similar source of air for combustion. An air filter (not shown) may be disposed between the air-line and an air intake line to filter air entering from the pollution control system 60, before mixing with fuel.

The pollution control system 60 is designed to vent the blow-by gases from the crankcase 72 to the combustion chamber to be recycled as fuel for the engine 74. This is accomplished by using the pressure differential between the crankcase 72 and the fuel intake. In operation, the blow-by gases exit the relatively higher pressure crankcase through a vent line 76, the PCV valve 62, and finally through a return line 78 and into the relatively lower pressure fuel intake coupled thereto. Accordingly, the quantity of blow-by gases vented from the crankcase 72 to the fuel intake via the PCV valve 62 is digitally regulated by the microcontroller 20.

The PCV valve 62 is generally electrically coupled to the microcontroller 20. The microcontroller 20 at least partly regulates the quantity of blow-by gases flowing through the PCV valve 62. In general, the microcontroller 20 operates a restrictor internal to the PCV valve 62 for regulating the rate of blow-by gases entering from the crankcase 72 and exiting to the fuel intake.

With reference now to FIG. 6, a schematic view of an engine 74 and the operation of the blow-by recycling system 60 in conjunction with a PCV valve 62 are shown. As illustrated, the PCV valve 62 is disposed in-line with a recirculating line 76 between the crankcase 72 of the engine 74 and the conjunction box 18 of the system 10. The sensors 64-70 supply the microcontroller with details about the operation of the engine so that the microcontroller can regulate to operation of the PCV valve 62 and the supply of fuel from the retro-fit system 10.

Although several embodiments have been described in detail for purposes of illustration, various modifications may be made without departing from the scope and spirit of the invention. Accordingly, the invention is not to be limited, except as by the appended claims.

What is claimed is:

1. An alternative fuel retrofit kit for an internal combustion engine, comprising:
a retrofit fuel tank;
a conjunction box fluidly connected to the retrofit fuel tank;
a plurality of fuel injectors fluidly connected to the conjunction box;
a fuel valve in the conjunction box fluidly in-line between the retrofit fuel tank and the plurality of fuel injectors; and
a microcontroller operatively connected to the fuel valve.

2. The alternative fuel retrofit kit of claim 1, further comprising a blow-by gas recirculating system comprising a PCV valve, a vent line fluidly connecting a crankcase of an engine to the PCV valve, and a recirculating line fluidly connecting the PCV valve to the conjunction box.

3. The alternative fuel retrofit kit of claim 2, wherein the microcontroller is operatively connected to the PCV valve and regulates an open/close state of the PCV valve in response to engine sensor signals.

4. The alternative fuel retrofit kit of claim 1, further comprising retrofit fuel injection rails and retrofit fuel injectors.

5. The alternative fuel retrofit kit of claim 4, wherein the retrofit fuel injection rails and retrofit fuel injectors are configured to deliver multiple types of fuel to the engine.

6. A process for installing a fuel retrofit kit on an internal combustion engine, comprising the steps of:
installing a retrofit fuel tank in a vehicle containing an engine;
installing a conjunction box in a compartment proximate to the engine;
installing retrofit fuel rails on the engine, wherein the retrofit fuel rails have a plurality of retrofit fuel injectors, each retrofit fuel injector corresponding to one of a plurality of piston cylinders in the engine;
fluidly connecting the retrofit fuel tank to a retrofit inlet on the conjunction box;
fluidly connecting an outlet on the conjunction box to the retrofit fuel rails;
operatively connecting a microcontroller to the conjunction box, wherein the microcontroller regulates a type and amount of fuel passing through the conjunction box.

7. The process of claim 6, wherein the retrofit fuel tank is installed in parallel with an old fuel tank, and further comprising the step of fluidly connecting the old fuel tank to an old fuel inlet on the conjunction box.

8. The process of claim 6, further comprising the steps of removing an old fuel tank from the vehicle, and removing old fuel rails and old fuel injectors from the engine.

9. The process of claim 6, further comprising the steps of installing a PCV valve proximate to the engine, fluidly connecting an inlet on the PCV valve to a crankcase on the engine, and fluidly connecting an outlet on the PCV valve to a blow-by inlet on the conjunction box, wherein the microcontroller blends the blow-by inlet with the fuel inlet.

10. The process of claim 6, wherein the step of fluidly connecting the retrofit fuel tank to a retrofit inlet on the conjunction box further comprises the step of running high pressure tubing and fittings between the fuel tank and the retrofit inlet.

11. The process of claim 10, further comprising the step of clamping the high pressure tubing and fittings to a chassis of the vehicle.

12. The process of claim 6, further comprising the steps of attaching sensor leads from an engine temperature sensor, a PCV valve sensor, a fuel tank sensor, or an exhaust sensor to the microcontroller, and programming the microcontroller with standard values for the engine temperature sensor, the PCV valve sensor, the fuel tank sensor, or the exhaust sensor corresponding to an alternative fuel in the retrofit fuel tank.
